(19) United States
(12) Patent Application Publication
(10) Pub. No.: US 2011/0159456 A1
(43) Pub. Date: Jun. 30, 2011

(54) Oral Care Suction Device With Suction Control Port Cover

(76) Inventors: Brian J. Cuevas, Cumming, GA (US); Jennifer Sturm Stadelman, Alpharetta, GA (US); Scott M. Teixeira, Cumming, GA (US)

(21) Appl. No.: 12/649,691

(22) Filed: Dec. 30, 2009

(51) Int. Cl. A61C 17/08

(52) U.S. Cl. 433/91

(57) ABSTRACT

An oral care suction device that includes a suction control port cover. The oral care suction device includes a body having a fluid flow passage formed therethrough. The body has a suctioning feature is located on or joined at its distal end. The body also has an attachment feature located at its proximal end. The oral care suction device also includes a suction control port located intermediate the distal end and proximal end of the body and configured to be covered by a finger or a portion of the hand of a user to alter the level of suction through the suctioning feature while allowing one hand operation of the suctioning device. The suction control port defines a channel from an exterior of the body to the fluid flow passage. A breathable fabric is positioned to cover the suction control port so that contact of the finger or portion of the hand of a user with liquids and particles drawn into and through the fluid flow passage during suctioning is minimized.

### FIELD OF THE INVENTION

The present invention relates to oral care devices for cleaning the mouth of a patient having a temporary or permanent disability interfering with the patient's ability to practice oral hygiene and in which one or more instruments are attachable to a suction source.

### BACKGROUND

There are many situations in which an individual is temporarily or permanently unable to practice oral hygiene in a convenient manner. One particular problem is presented by critical care patients in hospitals, as well as those in hospitals and nursing homes who require respirators to breath. Not only can the patient typically not walk or otherwise move to a restroom, the patient is often unable to hold the tooth brush and other oral hygiene instruments which are commonly used to keep one's mouth clean.

Because of these problems, the oral hygiene of many patients must be conducted by nurses or nurse's aides. The oral hygiene for each such patient must be worked in to an already hectic routine. Therefore, it is common for oral hygiene to be omitted on any given day, and it is not uncommon for a patient to go several days without proper oral hygiene.

Solutions in the form of suctioning or aspirating toothbrushes, suctioning swabs and the like have been developed for this purpose and are generally known. These devices typically include an elongated suction tube connectable at one end to a suction source.

A concern with the conventional devices is proper control of the suction force as well as cleanliness and the risk of contamination. The suction holes of these devices are typically positioned in a way that tends to bring them in contact with the soft tissue lining the mouth. If the tissue covers the holes, no suction relief is provided and the device can easily become stuck to the side of the patient's mouth. If the suction is sufficient, the tissue can be damaged as the device is pulled away.

During use, the suction swab or toothbrush end is typically submerged in an oral care solution so that the absorbent swab or the bristles of the toothbrush retain the solution. However, if suctioning force not properly controlled or if sufficient airflow is not provided through the suction control port, the container of solution may be inadvertently and quickly drained by the suction device without the knowledge of the nurse or nurse's aide. Moreover, improper control of the suctioning force or insufficient airflow through the suction control port may result in the solution being depleted from the suction swab or bristles of the toothbrush. For example, if a suction control button, control port, or sliding valve is partially closed by accident, a sufficient level of suctioning force can be directed to the suction tip submerged in a container of oral care solution (instead of being directed through a suction bypass or suction control opening) to suction the oral care solution from the container. Similarly, a sufficient level of suctioning force may be directed to the suction tip at the suction swab or the bristles of the toothbrush (instead of being directed through a suction bypass or suction control opening) to deplete the swab or toothbrush of oral care solution.

Suction swab and suction toothbrush devices are intended to be used only once and then disposed of. Accordingly, conventional devices have very simple designs so it is economical to use them only once. Many conventional devices use a simple configuration to activate or control the suction pressure. These devices employ a suction control port that can be partially or totally covered by a user's finger to adjust the level of suctioning force that is directed through the suction tip of the device. When the suction control port is uncovered, the suctioning force or vacuum is diverted from the suction tip of the device and flows through the uncovered suction control port instead. When the suction control port is covered, the suctioning force or vacuum is directed to the suction tip because it can no longer flow through the suction control port. A user can vary the level of suctioning force or vacuum at the suction tip by partially opening or covering the suction control port.

It quickly becomes apparent that such a configuration exposes the user's finger or hand to droplets or spatter of secretions and mucus. Even if the user is wearing gloves, the microbes present in the droplets or spatter of secretions, saliva and mucus can readily spread through contact transfer.

For example, FIG. 1 illustrates a conventional oral care suction device 10 such as, for example, a suctioning toothbrush, with a simple suction control port 12 that is gripped by a user with the user's thumb “T” removed from the suction control port 12 to reduce or eliminate the suctioning force that is applied to the suction tip 14.

FIG. 2 is an illustration of a conventional oral care suction device 10 gripped by a user with the user's thumb “T” covering from the suction control port (not shown) so that the suctioning force that is applied to the suction tip 14.

FIG. 3 is an illustration of a conventional oral care suction device 10 with a suction control port 12 illustrating a fluid passage 16 extending from the suction tip 14 which is in the form of a toothbrush bristle head 18 to a suction attachment 20. In order to operate effectively, the suction control port 12 must be fluid communication with the fluid passage 16 and the suctioning force is controlled by covering the suction control port totally or partially with a user's thumb. As discussed above, saliva, mucus and secretions that are suctioned through the suction tip 14 and entrained in the turbulent airflow passing though the fluid passage 16 frequently spatter or contact the thumb of the user thereby allowing the spread of microbes.

Various attempts have been made to address aspect of this problem. For example, U.S. Pat. No. 5,855,562 for a “Suction Control Valve” issued to Moore et al. teaches a valve that may be used with an oral care suction assembly or aspirator. According to Moore et al., the valve includes a bacteria filter that prevents passage of microorganisms, a splash guard that prevents liquids from contacting the bacteria filter, and a suction control port guard that is slidable or movable from a first position over the suction control port to a second portion allowing access to the suction control port. Such a valve is relatively complicated and expensive to produce because it has several components, including moving parts, and a bacteria filter. One particular disadvantage is that bacteria filters have low air permeability and require large surface areas to provide any meaningful airflow.

For example, FIG. 4 is an illustration of a tracheal suctioning catheter 300 formerly made by Vital Signs, Inc. The tracheal suctioning catheter is of a conventional design but also includes a suction control element 302 with a bacterial filter. A user controls suctioning by placing a finger over the suction control port 304 of the suction control element. The bacterial filter is used to prevent bacteria from entering the suction line because such a tracheal suctioning catheter is typically a limited use device that is used several times over one or more days on the same patient. The bacterial filter also prevents liquid from contacting the finger of the user who controls suctioning.

The bacterial filter is a two layer material containing a carded web layer that has been bonded by needlepunching and a layer of spunbond material. The carded web layer has a basis weight of about 520 grams per square meter and the spunbond layer has a basis weight of about 47 grams per square meter for a total basis weight of about 567 grams per square meter.

FIG. 5 is an illustration showing a detail of the suction control element 302 with a bacterial filter. The area of the suction control port 304 is approximately 80 square millimeters (mm²). The bacterial filter is contained in the housing 306 below the port. The area below the port which houses the filter is over 830 square millimeters (mm²) or over ten times (10×) the area of the suction control port. While such a design may be effective for a limited use tracheal suctioning catheter that is kept in place for several days or longer, it is impractical and not economical for single use oral care suction swab or toothbrush that is used and then disposed of each time a patient's mouth is cleaned which can be up to several times a day.

As another example, PCT International Publication WO 98/52626 for a “Nozzle for Surgical Suction Apparatus” to Gemmel et al., teaches a nozzle for surgical suctioning that includes a finger control aperture that is equipped with a filter in the form of a gas permeable, liquid impermeable membrane. However, such gas permeable, liquid impermeable membranes have a significant disadvantage in that such membranes have relatively low air permeability and require large surface areas to provide any meaningful airflow. Providing sufficient surface area for low permeability filter membranes to allow meaningful airflow adds expense and has few practical solutions except for a structure generally as illustrated in FIGS. 4 and 5 and/or pleating the membrane, both of which add expense and complexity to the design of devices that are used once and then thrown away. Moreover, Gemmel et al. identify no suitable materials and lack any description or examples of a suitable gas permeable membrane.

Accordingly, there is an unmet need for a simple and effective way to shield a user's finger or hand from droplets or spatter of secretions, saliva and mucus when using an oral care suction device having a simple suction control port. In addition, there is an unmet need for a reliable way to avoid directing suctioning force to the suction tip of an oral care device when the suction tip is submerged in an oral care solution or loaded with an oral care solution while also providing a simple and effective way to shield a user's finger or hand from droplets or spatter of secretions and mucus.

### SUMMARY OF THE INVENTION

In response to the difficulties and problems discussed herein, the present invention provides an oral care suction device that includes a suction control port cover that is sufficiently breathable to avoid suctioning and/or depleting oral care solution when the suction tip of the device is submerged in an oral care solution or loaded/saturated with an oral care solution while also providing a simple and effective way to shield a user's finger or hand from droplets or spatter of secretions and mucus. The oral care suction device includes a body having a fluid flow passage formed therethrough. The body has a distal end and a suctioning feature is located on or joined to the distal end. The body also has a proximal end an attachment feature located on the proximal end. The attachment feature is configured for joining the oral care suction device to a suction supply source. The suction feature and/or the attachment feature may be formed integrally with the body. That is, the suction feature and/or the attachment feature and the body may form a unitary structure. Alternatively, the suction feature and/or the attachment feature may be separate pieces that are joined to the body.

The oral care suction device also includes a suction control port configured to be covered by a finger or a portion of the hand of a user to alter the level of suction through the suctioning feature while allowing one hand operation of the suctioning device. The suction control port defines a channel from an exterior of the body to the fluid flow passage. In an aspect of the invention, suction control port may define a plurality of channels from the exterior of the body to the fluid flow passage. According to the invention, the suction control port is located intermediate the distal end and proximal end of the body. In an aspect of the invention, body may further include a projection having a proximal end joined with the body and a distal end and the suction control port suction control port defines a channel from the distal end of the projection to the fluid flow passage. This projection may be formed integrally with the body such that the projection and the body may form a unitary structure. Alternatively, the projection may be a separate piece that is joined to the body. According to an aspect of the invention, the cross-sectional area of the channel defined by the suction control port may range from about 20 square millimeters to about 120 square millimeters. For example, the cross-sectional area of the channel defined by the suction control port may range from about 60 square millimeters to about 100 square millimeters. As another example, the cross-sectional area of the channel defined by the suction control port may range from about 75 square millimeters to about 95 square millimeters. The cross-sectional areas specified for the channel defined by the suction control port are possible because special suction port housings such as those described in FIGS. 4 and 5 are not needed because the air permeability of the breathable fabric is sufficiently high without compromising barrier properties.

An important feature of the oral care suction device is a breathable fabric which is positioned to cover the suction control port so that contact of the finger or portion of the hand of a user with liquids and particles drawn into and through the fluid flow passage during suctioning is minimized. Desirably, the breathable fabric includes one or more layers of spunbond fabric and has a level of breathability sufficient to allow immersion of the suctioning feature in a liquid while the suction control port is uncovered by the finger or portion of the hand of a user without drawing off the liquid by suctioning. For example, the air permeability of the breathable fabric is desirably greater than about 60 ft³ per minute per ft² (1820 cm³ per minute per cm²) at a pressure condition of 125 pascals. As another example, the air permeability of the breathable fabric is desirably greater than about 200 ft³ per minute per ft² (6100 cm³ per minute per cm²) at a pressure condition of 125 pascals. As another example, the air permeability of the breathable fabric is desirably greater than about 400 ft³ per minute per ft² (12100 cm³ per minute per cm²) at a pressure condition of 125 pascals. That is, the combination of the air permeability of the breathable fabric and the cross-sectional area of the channel defined by the suction control port should be sufficient to allow immersion of the suctioning feature in a liquid while the suction control port is uncovered by the finger or portion of the hand of a user without drawing off the liquid by suctioning.

In an aspect of the invention, the breathable fabric desirably has a surface energy of less than about 45 dynes per centimeter (dynes/cm). For example, the breathable fabric desirably has a surface energy ranging from about 29 to about 35 dynes per centimeter (dynes/cm). The breathable fabric may desirably have liquid barrier properties characterized by a resistance to water penetration as measured by a hydrostatic head of at least about 5 cm. For example, breathable fabric desirably has liquid barrier properties characterized by a resistance to water penetration as measured by a hydrostatic head of from about 5 cm to about 30 cm or greater.

### BRIEF DESCRIPTION OF THE DRAWINGS

The above and other objects, features and advantages of the invention will become apparent from a consideration of the following detailed description presented in connection with the accompanying drawings in which:

FIG. 1 is an illustration showing a perspective view of an oral care suction device with a conventional suction control port during use;

FIG. 2 is an illustration showing a perspective view of an oral care suction device with a conventional suction control port during use;

FIG. 3 is an illustration showing a perspective view of an oral care suction device with a conventional suction control port during use;

FIG. 4 is an illustration showing a perspective view of a tracheal suctioning device with a conventional suction control port incorporating a bacteria filter;

FIG. 5 is an illustration showing a perspective view of a detail of a tracheal suctioning device with a conventional suction control port incorporating a bacteria filter;

FIG. 6 is an illustration showing a perspective view of an exemplary oral care suction device including a suction control port cover;

FIG. 7 is an illustration showing a cross-section view of an exemplary oral care suction device including a suction control port cover from FIG. 6;

FIG. 8 is an illustration showing a perspective view of a detail of an exemplary oral care suction device including a suction control port cover;

FIG. 9 is an illustration showing a perspective view of a detail of an exemplary oral care suction device including a suction control port cover;

FIG. 10 is an illustration showing a perspective view of a detail of an exemplary oral care suction device including a suction control port cover;

FIG. 11 is an illustration showing a cross-section view of an exemplary oral care suction device including a suction control port cover;

FIG. 12 is an illustration showing a cross-section view of an exemplary oral care suction device including a suction control port cover;

FIG. 13 is an illustration showing a cross-section view of an exemplary oral care suction device including a suction control port cover; and

FIG. 14 is an illustration showing a perspective view of an exemplary oral care suction device including a suction control port cover.

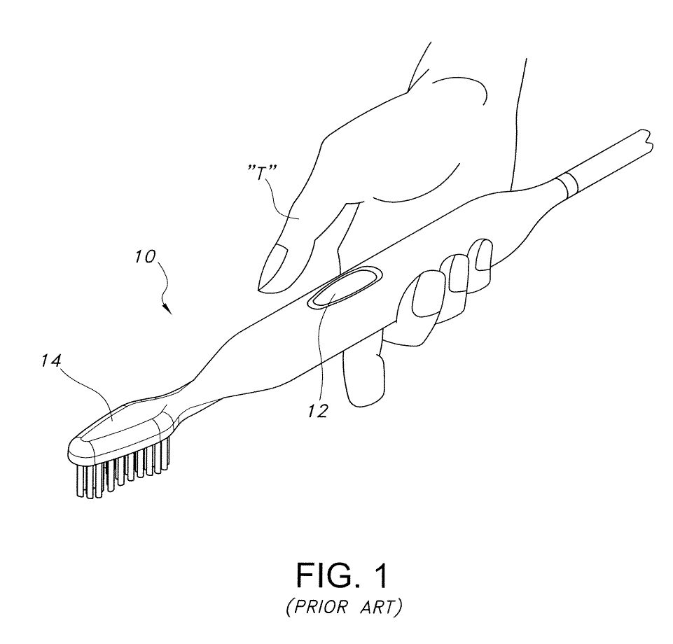

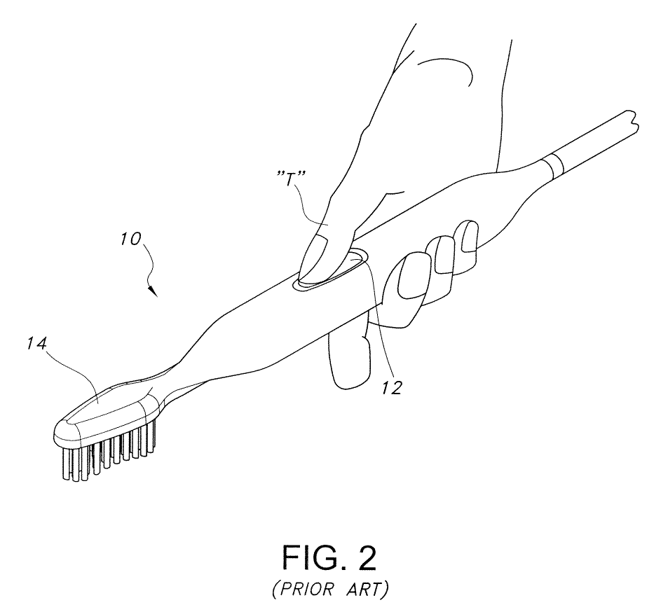

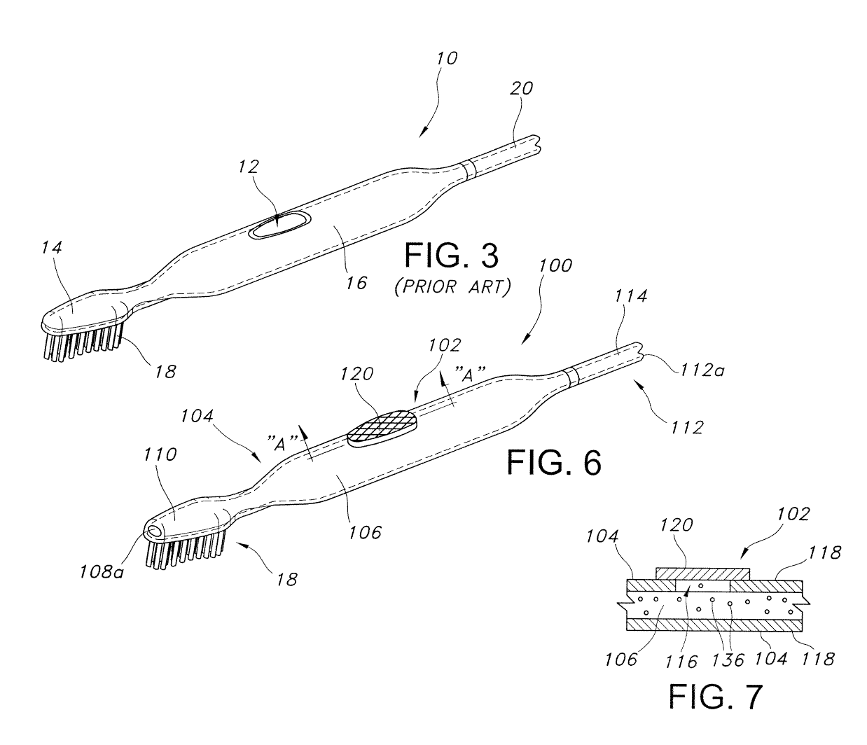

### DETAILED DESCRIPTION

Reference will now be made to the drawings in which the various elements of the present invention will be given numeral designations and in which the invention will be discussed so as to enable one skilled in the art to make and use the invention. It is to be understood that the following description is only exemplary of the principles of the present invention, and should not be viewed as narrowing the pending claims.

Referring now to FIG. 6, there is shown an illustration of an oral care suction device 100 that includes a feature to address the deficiencies of conventional oral care suction devices. The oral care suction device 100 includes a body 104 having a fluid flow passage 106 formed therethrough.

The body has a distal end 108 and a suctioning feature 110 is located on or joined to the distal end 108. The suctioning feature 110 may be a suction toothbrush, a suction swab, a dentaswab, a yankauer, a simple suction tip or the like. The body 104 also has a proximal end 112 an attachment feature 114 located on the proximal end 112. The attachment feature 114 is configured for joining the oral care suction device 100 to a suction supply source. The oral care suction device 100 is illustrated in the form of a toothbrush. Other configurations such as suctioning swabs and the like are encompassed by the present invention. The fluid flow passage 106 in the toothbrush configuration includes an elongate fluid flow passage 106 which extends from a distal opening 108a at the distal end 108 of the toothbrush, to a proximal opening 112a at the proximal end 112 of the toothbrush. In the toothbrush configuration, the fluid flow passage 106 is substantially linear, so that food particles and liquids can be drawn into the distal opening 108a and provided with a straight flow path.

The suction feature 110 and/or the attachment feature 114 may be formed integrally with the body 100. That is, the suction feature and/or the attachment feature and the body may form a unitary structure. Alternatively, the suction feature and/or the attachment feature may be separate pieces that are joined to the body.

The oral care suction device 100 also includes a suction control port 102 configured to be covered by a finger or a portion of the hand of a user to alter the level of suction through the suctioning feature while allowing one hand operation of the suctioning device.

FIG. 7 is a cross-sectional side view of the device illustrated in FIG. 4 taken along line “A”-“A”. As illustrated in FIG. 6, the suction control port 102 defines a channel 116 from an exterior 118 of the body to the fluid flow passage 106. Mucus, saliva, secretions and other materials 136 entrained in the suctioning flow are shown in the fluid flow passage 106.

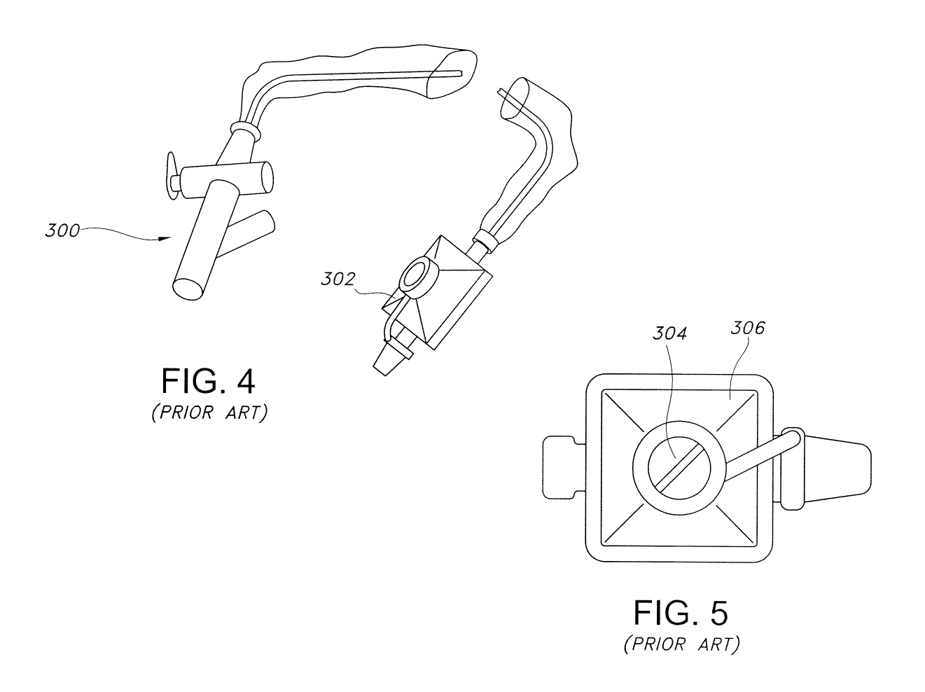

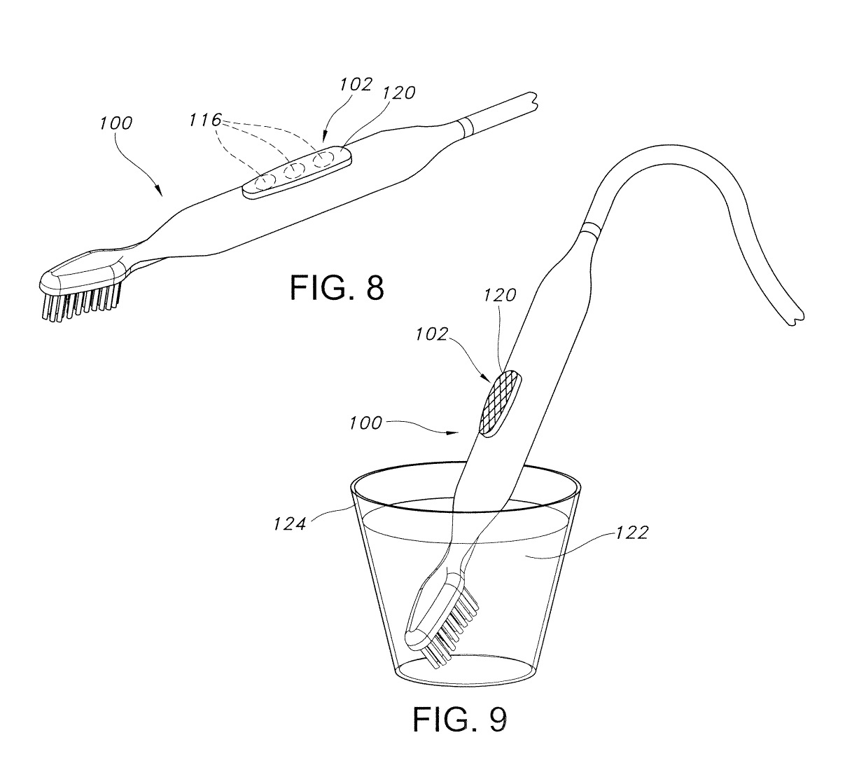

In an aspect of the invention, suction control port 102 may define a plurality of channels 116 from the exterior 118 of the body to the fluid flow passage 106. This detail is generally illustrated in FIG. 8 which shows a suction control port 102 that defines three openings or channels 116. It is contemplated that a larger number of smaller channels may be used or a smaller number of larger channels may be used.

The suction control port 102 is desirably located intermediate the distal end 108 and proximal end 112 of the body. Generally speaking, the suction control port is located on an upper surface of the body so the mucus, saliva and secretions do not tend to drain out of the suction control port.

According to an aspect of the invention, the cross-sectional area of the channel defined by the suction control port may range from about 20 square millimeters to about 120 square millimeters. For example, the cross-sectional area of the channel defined by the suction control port may range from about 60 square millimeters to about 100 square millimeters. As another example, the cross-sectional area of the channel defined by the suction control port may range from about 75 square millimeters to about 95 square millimeters. According to the invention, the cross-sectional area of the channel 116 can be relatively or substantially uniform from the exterior of the body 118 to the fluid flow passage 106 because additional surface area is not needed due to the air permeability of the breathable fabric.

An important feature of the oral care suction device 100 is a breathable fabric 120 which is positioned to cover the suction control port 102 so that contact of the finger or portion of the hand of a user with liquids and particles drawn into and through the fluid flow passage during suctioning is minimized. Generally speaking, contact of the finger or portion of the hand of a user with liquids and particles drawn into and through the fluid flow passage during suctioning is “minimized” when there is an absence of any visible sign of liquid penetration through the breathable fabric or an absence of any visible sign of liquid on the finger or portion of the hand of a user used to occlude the suction control port. For example, when the suctioning feature at the distal end of the suctioning device is immersed in a container of liquid containing a dark food coloring or dark dye and that liquid is suctioned through the device and there is an absence of any visible sign of the food coloring or dye on the finger (or glove-covered finger) used to occlude the suction control port (e.g., by contact with the breathable fabric on the suction control port or by contact with the projection, if any, that may extend to create a gap between the finder and the breathable fabric), that would be evidence that contact of the finger or portion of the hand of a user with liquids and particles drawn into and through the fluid flow passage during suctioning is “minimized”. When the suctioning feature at the distal end of the suctioning device is immersed in a container of liquid containing a dark food coloring or dark dye and that liquid is suctioned through the device and there is any visible sign of the food coloring or dye on the finger (or glove-covered finger) used to occlude the suction control port (e.g., by contact with the breathable fabric on the suction control port or by contact with the projection, if any, that may extend to create a gap between the finder and the breathable fabric), that would be evidence that contact of the finger or portion of the hand of a user with liquids and particles drawn into and through the fluid flow passage during suctioning has not been “minimized”.

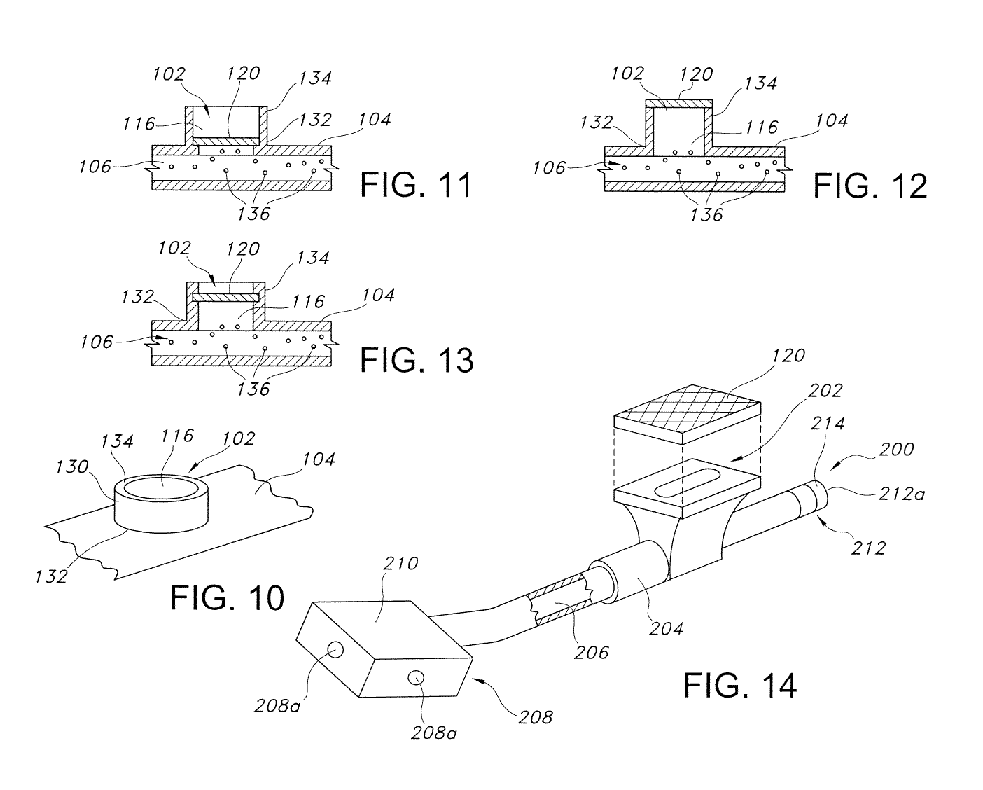

In an aspect of the invention, the contact of the finger or portion of the hand of a user with liquids and particles drawn into and through the fluid flow passage during suctioning is desirably eliminated. Generally speaking, it is thought that the use of a projection to separate the finger of the user from the breathable fabric as generally illustrated in FIGS. 10-14 in combination with a breathable fabric having good barrier properties can eliminate the contact of the finger or portion of the hand of a user with liquids and particles drawn into and through the fluid flow passage during suctioning while still providing sufficiently high levels of breathability to avoid disadvantages such as, for example, inadvertently suctioning off liquid when the end of the suctioning device is immersed in the liquid and/or depleting a saturated swab or toothbrush of liquid.

As illustrated in FIG. 9, the breathable fabric 120 desirably has a level of breathability (i.e., air permeability) sufficient to allow immersion of the suctioning feature 110 at the distal end 108 of the device in a liquid 122 (e.g., oral care solution) held in a container 124 while the suction control port is uncovered by the finger or portion of the hand of a user without drawing off the liquid by suctioning. The liquid may be any conventional oral care liquid including, but not limited to, an oral care cleaning solution, an anti-plaque solution, an oral debridement solution, a mouthwash, a moisturizer, a dentifrice, toothpaste or tooth cleaning solution, and combinations of the above. Desirably, the breathable fabric 120 desirably has a level of breathability (i.e., air permeability) sufficient to allow immersion of the suctioning feature in a container of liquid with suction swab held at an angle of about 45 degrees to about 90 degrees from the horizontal plane (or about 45 degrees to about 0 degrees from the vertical plane) while the suction control port is uncovered by the finger or portion of the hand of a user without drawing off the liquid by suctioning. Generally speaking, the closer the angle to the horizontal plane that the suction swab is held, the greater the breathability required from the breathable fabric. More desirably, the breathable fabric 120 desirably has a level of breathability (i.e., air permeability) sufficient to allow immersion of the suctioning feature in a container of liquid with suction swab was held at an angle of about 55 degrees to about 75 degrees from the horizontal plane (or about 15 degrees to about 35 degrees from the vertical plane) while the suction control port is uncovered by the finger or portion of the hand of a user without drawing off the liquid by suctioning. In an aspect of the invention, the breathable fabric should allow diversion of suctioning force through the suction control port to avoid depleting the saturated swab or toothbrush of oral care solution while the suction control port is uncovered by the finger or portion of the hand of a user.

The breathable fabric also may desirably possess a degree of repellency to water and low surface tension liquids such as salt-laden water, alcohols, and hydrophilic liquids, such as those containing surfactants or detergents or other cleaning compositions, in order to more fully provide a barrier to passage of liquids through the suction control port. The liquid repellent properties of the nonwoven also help to protect against the structural collapse of the fabric which may occur when an open fibrous structure is wetted.

According to an aspect of the invention, the breathable fabric 120 desirably has a surface energy of less than about 45 dynes per centimeter (dynes/cm). For example, the breathable fabric desirably has a surface energy ranging from about 29 to about 35 dynes per centimeter (dynes/cm). These surface energy levels are generally considered to be “relatively low surface energy”. As used herein, the term “relatively low surface energy” refers to surface energies (i.e., surface free energies) attributed to materials that are not generally considered to be water wettable. Generally speaking, such materials have a surface energy of less than about 45 dynes per centimeter (dynes/cm) as determined in accordance with critical surface tension of wetting techniques described by Bennet, M. K. and Zisman, W. A.; Relation of Wettability by Aqueous Solutions to the Surface Constitution of Low Energy Solids; J. Phys. Chem., pps. 1241-1246, Volume 63 (1959). Many such materials have a surface energy ranging from about 29 to about 35 dynes/cm. Exemplary materials include polyolefins such as, for example, polypropylene and/or materials including treatment additives such as, for example, fluorochemicals, to provide repellency to water and low surface tension fluids.

The breathable fabric 120 may desirably have liquid barrier properties characterized by a resistance to water penetration as measured by a hydrostatic head of at least about 5 cm. For example, breathable fabric desirably has liquid barrier properties characterized by a resistance to water penetration as measured by a hydrostatic head of from about 5 to 10 cm or greater. The term “Hydrostatic Head” refers to a measure of the liquid barrier properties of a fabric as determined by the hydrostatic head test. The hydrostatic head test determines the height of water (in centimeters) which the fabric will support before a predetermined amount of liquid passes through. A fabric with a higher hydrostatic head reading indicates it has a greater barrier to liquid penetration than a fabric with a lower hydrostatic head. The hydrostatic head test is performed according to Federal Test Standard 191A, Method 5514. The test is modified to include a screen support of standard synthetic fiber window screen material. The test head of a Textest FX-300 Hydrostatic Head Tester, available from Schmid Corporation, having offices in Spartanburg, S.C. was filled with purified water. The purified water was maintained at a temperature between 65° F. and 85° F. (between about 18.3° C. and 29.4° C.), which was within the range of normal ambient conditions (about 73° F. (about 23° C.) and about 50% relative humidity) at which this test was conducted. An 8 inch by 8 inch (about 20.3 cm by 20.3 cm) square sample of the test material was placed such that the test head reservoir was covered completely. The sample was subjected to a standardized water pressure, increased at a constant rate until leakage was observed on the outer surface of the sample material. Hydrostatic pressure resistance was measured at the first sign of leakage in three separate areas of the sample. This test was repeated for forty specimens of each sample material. The hydrostatic pressure resistance results for each specimen were averaged and recorded in millibars. Again, a higher value indicates greater resistance to water penetration and is desirable for barrier applications.

According to an aspect of the invention and as illustrated in FIG. 10, the body 104 may further include a projection 130 having a proximal end 132 joined with the body 104 and a distal end 134 and the suction control port 102 defines a channel 116 from the distal end 134 of the projection 130 to the fluid flow passage 106 which is not shown in FIG. 10. Such a projection helps separate the user's finger from the materials entrained in the suctioning flow passing through the body of the device via the fluid flow passage 106. This projection may be formed integrally with the body such that the projection 130 and the body 104 may form a unitary structure. Alternatively, the projection may be a separate piece that is joined to the body. FIGS. 11 through 13 illustrate several configurations in which the breathable fabric 120 is integrated or incorporated with the projection 130.

FIG. 11 is a cross sectional, side view illustrating the location of the breathable fabric 120 at the proximal end 132 of the projection 130 where it joins the body 104 of the device to provide a barrier at the suction control port 102 that keeps material 136 (e.g., saliva, secretions and mucus, etc.) entrained in the suction flow through the fluid flow passage 106 from contacting the finger of a user. The projection 130 defines a channel 116 from the distal end 134 of the projection 130 to the fluid flow passage 106 FIG. 12 is a cross sectional, side view illustrating the location of the breathable fabric 120 at the distal end 134 of the projection 130 to provide a barrier at the suction control port 102 that keeps material 136 (e.g., saliva, secretions and mucus, etc.) entrained in the suction flow through the fluid flow passage 106 in the body 104 of the device from contacting the finger of a user. FIG. 13 is a cross sectional, side view illustrating the location of the breathable fabric 120 intermediate the proximal end 132 and the distal end 134 of the projection 130 to provide a barrier at the suction control port 102 that keeps material 136 (e.g., saliva, secretions and mucus, etc.) entrained in the suction flow through the fluid flow passage 106 in the body 104 of the device from contacting the finger of a user. According to the invention, the cross-sectional area of the channel 116 can be relatively or substantially uniform from the exterior of the body 118 to the fluid flow passage 106 because additional surface area is not needed due to the relatively high level of air permeability provided by the breathable fabric.

FIG. 14 is a perspective view of another aspect of the invention as it relates to a suctioning swab 200. The suctioning swab 200 includes a body 204 having a fluid flow passage 206 formed therethrough. The body has a distal end 208 and a suctioning feature 210 (i.e., suction swab) is located at the distal end 208. The body 204 also has a proximal end 212 an attachment feature 214 located on the proximal end 212. The attachment feature 214 is configured for joining the oral care suction device 200 to a suction supply source. The fluid flow passage 206 in the suctioning swab configuration includes an elongate fluid flow passage 206 which extends from a distal opening 208a at the distal end 208 of the suctioning swab 200, to a proximal opening 212a at the proximal end 212 of the suctioning swab 200. The suction feature 210 and/or the attachment feature 214 may be formed integrally with the body 204. That is, the suction feature and/or the attachment feature and the body may form a unitary structure. Alternatively, the suction feature and/or the attachment feature may be separate pieces that are joined to the body.

The suctioning swab 200 also includes a suction control port 202 configured to be covered by a finger or a portion of the hand of a user to alter the level of suction through the suctioning feature while allowing one hand operation of the suctioning device. The suction control port 202 is desirably located intermediate the distal end 208 and proximal end 212 of the body. Generally speaking, the suction control port is located on an upper surface of the body so the mucus, saliva and secretions do not tend to drain out of the suction control port. An important feature of the suctioning swab 200 is a breathable fabric 120 which is positioned to cover the suction control port 202 so that contact of the finger or portion of the hand of a user with liquids and particles drawn into and through the fluid flow passage during suctioning is minimized.

As noted above, the breathable fabric 120 desirably has a level of air permeability sufficient to allow immersion of the suctioning feature 110 at the distal end 108 of the device in a liquid 122 held in a container 124 while the suction control port is uncovered by the finger or portion of the hand of a user without drawing off the liquid by suctioning. While the level of air permeability to achieve this may be influenced by aspects of the oral care suction device 100 including, but not limited to, the size/area of the suction control port 102, the diameter of the fluid passage 106, the size of the openings associated with the suctioning feature 110, the level of suctioning force applied to the oral care suction device 100, it is generally thought that the air permeability of the breathable fabric is desirably greater than about 60 ft³ per minute per ft² (1820 cm³ per minute per cm²) at a pressure condition of 125 pascals (i.e., a pressure condition across the breathable fabric as generated by the FX 3300 Air Permeability device manufactured by Textest AG (Zurich, Switzerland), set to a pressure of 125 pascals (Pa) with the normal 7-cm diameter opening (38 square centimeters area)). For example, the air permeability of the breathable fabric is desirably greater than about 60 ft³ per minute per ft² (1820 cm³ per minute per cm²) at a pressure condition of 125 pascals (i.e., a pressure condition across the breathable fabric as generated by the FX 3300 Air Permeability device manufactured by Textest AG (Zurich, Switzerland), set to a pressure of 125 pascals (Pa) with the normal 7-cm diameter opening (38 square centimeters area)). As another example, the air permeability of the breathable fabric is desirably greater than about 200 ft³ per minute per ft² (6100 cm³ per minute per cm²) at a pressure condition of 125 pascals. As another example, the air permeability of the breathable fabric is desirably greater than about 400 ft³ per minute per ft² (12100 cm³ per minute per cm²) at a pressure condition of 125 pascals.

As used herein, the “Air Permeability” of the breathable fabric 120 may be measured with the FX 3300 Air Permeability device manufactured by Textest AG (Zurich, Switzerland), set to a pressure of 125 pascals (Pa) with the normal 7-cm diameter opening (38 square centimeters area), which gives readings of Air Permeability in cubic feet per minute (CFM) that are comparable to well-known Frazier Air Permeability measurements performed according to Federal Test Standard 191A, Method 5450, dated Jul. 20, 1978, and reported as an average of 3 sample readings as the airflow rate through a web in cubic feet of air per square foot of web per minute or CFM.

The breathable fabric is desirably a nonwoven web. As used herein, the term “nonwoven web” refers to a web having a structure of individual fibers or threads which are interlaid, but not in an identifiable manner as in a knitted fabric. Nonwoven webs or fabrics have been formed from many processes, such as, for example, meltblowing processes, spunbonding processes, and bonded carded web processes. The basis weight of nonwoven fabrics is usually expressed in ounces of material per square yard (osy) or grams per square meter (gsm) and the fibers diameters are usually expressed in microns. (Note that to convert from osy to gsm, multiply osy by 33.91).

Desirably, the nonwoven web is a spunbond web or which may be referred to as a web of spunbond fibers or spunbond filaments or simply as spunbond or spunbond material. As used herein, “spunbond fibers” or “spunbond filaments” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., U.S. Pat. No. 3,692,618 to Dorschner et al., U.S. Pat. No. 3,802,817 to Matsuki et al., U.S. Pat. No. 3,338,992 to Kinney, U.S. Pat. No. 3,341,394 to Kinney, U.S. Pat. No. 3,502,763 to Hartman, and U.S. Pat. No. 3,542,615 to Dobo et al. Spunbond fibers are generally not tacky when they are deposited on a collecting surface. Spunbond fibers are generally continuous and have average diameters (from a sample of at least 10) larger than 7 microns, and more particularly, between about 10 and 40 microns. For purposes of the present invention, it is desirable that the spunbond fibers have large diameters. The breathable fabric may include a microfiber web layer such as a meltblown web layer as is known in the art. Meltblown fiber layers are very useful for providing a layer having at least partial resistance to the passage of liquids, while still allowing gases and vapors such as air and water vapor to pass through. However, it may be necessary to substantially reduce or eliminate the meltblown fiber layer in order for the laminate to provide sufficient levels of air permeability. Such meltblown webs may be produced as described above according to the methods generally disclosed in, for example, U.S. Pat. No. 3,849,241 to Buntin, U.S. Pat. No. 4,307,143 to Meitner et al., and U.S. Pat. No. 4,707,398 to Wisneski et al. Also, multicomponent microfibers such as bicomponent or multicomponent meltblown microfibers are known in the art and may desirably be utilized. Multicomponent fibers in meltblowing production processes are described in U.S. Pat. No. 6,461,133 to Lake et al. and U.S. Pat. No. 6,474,967 to Haynes et al., both incorporated herein by reference in their entireties.

Where a meltblown web is used in the barrier fabric, it is desirable for the meltblown web to have a much lower pressure drop than is typical for such materials and very high permeability. Web density and web pore size, and pore size distribution all have an effect on the pressure drop and permeability. For example, such a meltblown web may desirably have a density less than about 50 kg/m³. Fiber sizes have an effect on the pore sizes of the web, with finer (smaller diameter) fibers tending to contribute to a smaller effective pore size in the web material. Therefore, where the breathable fabric contains a meltblown web it is desirable for the average meltblown fiber diameter to be as large as practical, such as, for example, diameters of 10 microns or greater. Exemplary meltblown web materials which may be utilized in the practice of the invention are disclosed in co-assigned published U.S. Pat. No. 6,893,711 to Williamson et al., issued May 17, 2005.

The breathable fabric may desirably include multiple nonwoven web layers. As an example, the breathable fabric may include a composite or laminate of multiple nonwoven web materials, such as for example spunbond-spunbond laminate materials. Other laminate materials may include spunbond-meltblown (“SM”) laminate materials or spunbond-meltblown-spunbond (“SMS”) laminate materials. Exemplary SM and SMS laminate materials are disclosed in U.S. Pat. No. 4,041,203 to Brock et al., U.S. Pat. No. 5,169,706 to Collier, et al. and U.S. Pat. No. 4,374,888 to Bornslaeger, all incorporated herein by reference in their entireties. An exemplary two-layer laminate, such as an SM laminate material, may include a first layer and a second layer. Either or both of the first and second layers may desirably include one or more treatment additives to impart repellency to water and low surface tension fluids. However, it is desirable that at least the nonwoven web layer which faces the fluid passage 106 should include a repellency treatment additive. As layers are added, it is important for the laminate to maintain a high level of air permeability.

It should be noted that bonding between layers of a laminate or composite is optional. That is, a laminate or composite material may be constructed by simply layering the component materials together without bonding, or by bonding either substantially continuously or intermittently along the face-to-face plane of the component layers, or by bonding only the edges of the layers together to form a composite or laminate having the layers bonded together along a portion or the entirety of the periphery of the composite. Where bonding of layers is desired it may be done by any suitable methods as are known in the art, such as thermal bonding, ultrasonic bonding, stitch bonding, adhesive bonding, needling or entangling and the like.

As another example, the breathable fabric may comprise a laminate of nonwoven web layers which includes a high-loft nonwoven web material. High-loft materials often incorporate mechanically or helically crimped fibers to produce a web having more void volume between the fibers, and thus a less dense and loftier web structure. Desirably, such lofty nonwoven webs have a density of less than about 50 kg/m³, and still more desirably a density less than about 30 kg/m³. For particular applications, such lofty webs may desirably have a density of less than about 20 kg/m³, or a density less than about 10 kg/m³, or even a density less than about 5 kg/m³. Examples include bonded carded webs of staple fibers and various lofty spunbond webs of multicomponent fibers such as those described in U.S. Pat. No. 5,382,400 to Pike et al., incorporated herein by reference in its entirety, and in co-assigned U.S. Pat. No. 7,291,239 to Polanco et al., issued Nov. 6, 2007, incorporated herein by reference in its entirety. In addition, lofty spunbond webs utilizing or incorporating crimped monocomponent fibers are also known in the art, and such may be produced utilizing the teachings disclosed in U.S. Pat. No. 6,632,386 to Shelley and Brown, U.S. Pat. No. 6,446,691 to Maldonado et al. and U.S. Pat. No. 6,619,947 to Maldonado et al., all incorporated herein by reference in their entireties.

Examples of such laminates including a high-loft nonwoven web material include meltblown/high-loft laminates, spunbond/high-loft laminates, SM/high-loft laminates, SMS/high-loft laminates, and the like. Exemplary multi-layer laminate materials include a high-loft nonwoven web layer. The layers together may desirably form a spunbond-spunbond type laminate material as discussed above, with the two layers being spunbond layers. As mentioned above, the layers of such a laminate or composite may be bonded together as described above, or may be simply layered together.

Whether the breathable fabric includes a single layer or multiple layers, it is very desirable that at least one nonwoven web layer include a treatment additive which assists the breathable fabric to be repellent to fluids such as water or low surface tension fluids. Low surface tension fluids include, for example, salt-laden water, alcohol-water mixtures, and hydrophilic liquids, such as those containing surfactants or detergents or other cleaning compositions. Where the breathable fabric includes multiple layers, at least the nonwoven web layer which is closest to or faces the fluid passage 106 should include a repellency treatment additive.

As a specific example, the breathable fabric may include a spunbond-spunbond or S-S laminate material as discussed above, and at least the spunbond web layer of the S-S laminate which faces the fluid passage 106 should include a low surface tension fluids repellency treatment additive. In addition, where additional levels of repellency are desired, other layers of the S-S laminate may also desirably include a low surface tension fluids repellency treatment.

As another example, where the breathable fabric comprises a laminate of nonwoven web layers which include a high-loft nonwoven web material as discussed above, at least the web layer of the laminate which faces the fluid passage 106 should include a low surface tension fluids repellency treatment additive. For example, where the breathable fabric comprises a high loft laminate material, the portion of the laminate that is not a high loft material may desirably be the fluid passage-facing portion of the breathable fabric and therefore at least that portion should have a treatment for low surface tension fluids repellency.

As stated, at least the fluid passage-facing portion of the breathable fabric should include a treatment additive which provides repellency to water and low surface tension fluids. Additive treatments comprising fluorine, for example, are useful treatments for producing repellency to water and other liquids. Fluorochemical repellents and particularly fluorochemicals comprising perfluorinated aliphatic groups (i.e., fully fluorinated) are well known in the art.

Fluorochemicals can be produced using a telomer chemistry process, which generally use an alkyl linking group such as an ethylene linking group (—C2H4-) between the fluoroaliphatic group and the hydrocarbon chain making up the remainder of the fluorochemical or fluoropolymer. Telomer chemistry processes are known to produce fluorochemicals having a distribution of fluoroaliphatic group lengths. For example, a single run or batch of such a process may produce fluorochemicals having perfluorohexane groups, perfluorooctane groups, perfluorodecane groups, etc., often with the majority of the fluoroaliphatic groups being perfluorooctane groups. Exemplary fluorochemicals are disclosed, for example, in U.S. Pat. No. 5,681,963 to Liss, U.S. Pat. No. 5,789,491 to Liss et al., and U.S. Pat. No. 5,898,046 to Raiford et al., all incorporated herein by reference in their entireties. Suitable fluorochemicals are available from the E. I. du Pont de Nemours and Company of Wilmington, Del. and sold under the brand name ZONYL®, and available from Daikin America, Inc. of Orangeburg, N.Y., under the trade name UNIDYNE.

Other fluorochemicals are known to be produced by electrochemical processes, such as the fluorochemical repellents disclosed in U.S. Pat. No. 5,025,052 to Crater et al., incorporated herein by reference in its entirety. Electrochemically produced fluorochemicals typically have a sulfonamide linking group (—S(O2)N(R)—) between the fluoroaliphatic group and the hydrocarbon chain making up the remainder of the fluorochemical or fluoropolymer, although other linking groups, and particularly hetero atom containing groups such as —O—, —S—, —SO—, etc. may be used. Electrochemical production processes generally result in essentially a non-distribution of fluoroaliphatic groups, i.e. a single moiety of the fluoroaliphatic groups linked to the hydrocarbon chain, such as for example (where the linking group is a sulfonamide group) a perfluorobutanesulfonamide group or a perfluorooctanesulfonamide. Other exemplary fluorochemical compounds are disclosed in U.S. Pat. No. 5,149,576 to Potts et al. and U.S. Pat. No. 5,178,931 to Perkins et al., both incorporated herein by reference in their entireties.

If they are used, such low surface tension fluids repellency treatment additives may be added to a nonwoven web in an amount from greater than 0% by weight of the nonwoven web up to about 5% by weight. More particularly, such repellency treatment additives, such as fluorochemicals, may be added to a nonwoven web in an amount from about 0.1% to about 4% by weight, and still more particularly in an amount from about 0.25% to about 2.5% by weight of the nonwoven web. One or more low surface tension fluids repellency treatment additives may be applied topically, or as internal melt additives, or both.

Processes or methods for topical treatment of additives onto web materials are well known in the art and include for example application of a treatment-containing liquid, such as a solution, emulsion or suspension of the treatment additive in a carrier liquid, onto the web material to be treated. Such a treatment-containing liquid may be applied to the web material using brush treaters, spray treaters, foam treaters or saturation/immersion bath treaters. Then, after the treatment-containing liquid has been applied to the web material, the web may be allowed to dry or may be dried by applied vacuum, heated air, radiant heat such as infrared heating or radio frequency heating, contact heat such as by passing the web over steam-heated canisters, etc., or combinations thereof.

As an alternative to (or in addition to) topical treatment, a repellency treatment may be incorporated directly into the fibers of a nonwoven web material via melt extrusion of one or more additive. Such internal melt additives may be added directly to the thermoplastic polymer melt composition which is to produce the fibers of the nonwoven web. For ease of incorporating such melt additives, the additive may be compounded with a base of one or more polymers. For example, one or more fluorochemicals mentioned above may be compounded into an additive-polymer compound as a “masterbatch” or “concentrate” at (for example) a 20 percent by weight loading level. Then, during the melt production of fibers, if the 20 percent additive-polymer concentrate is added to the other virgin polymer or polymers to be extruded at a rate of 5 kilograms of additive-polymer compound to 95 kilograms of virgin polymer, the resulting fibers contain about 1 percent by weight of the melt additive.

As stated, one or more of the nonwoven webs of the breathable fabric may include multicomponent fibers. In this regard, where the low surface tension fluids repellency treatment is added to the fibers via internal melt addition instead of or in addition to topical treatment, it may be possible to reduce the amount of repellency treatment required to produce the desired repellent effects by either using the repellency treatment in less than all of the components of a multicomponent fiber, or by using the repellency treatment in all components but using decreased concentrations in one or more of the components.

Polymers known to be generally suitable for melt extrusion of fibers and fibrous nonwoven webs include polyolefins, polyesters, polyamides, polycarbonates and copolymers and blends thereof. Suitable polyolefins include polypropylene, e.g., isotactic polypropylene, syndiotactic polypropylene, blends of isotactic polypropylene and atactic polypropylene; polyethylene, e.g., high density polyethylene, medium density polyethylene, low density polyethylene and linear low density polyethylene; polybutylene, e.g., poly(1-butene) and poly(2-butene); polypentene, e.g., poly(1-pentene) and poly(2-pentene); poly(3-methyl-1-pentene); poly(4-methyl-1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include polyethylene terephthalate, poly-butylene terephthalate, polytetramethylene terephthalate, polycyclohexylene-1,4-dimethylene terephthalate, and isophthalate copolymers thereof, as well as blends thereof. Selection of polymers for fibers and/or films is guided by end-use need, economics, and processability. The list of suitable polymers herein is not exhaustive and other polymers known to one of ordinary skill in the art may be employed.

### Examples

### Suction Control Port Cover with a Suction Swab

This example illustrates the use of a suction control port cover with a suction swab. A Toothette® Oral Care Suction Oral Swab available from Sage Products, Inc., of Cary, Ill., was connected to a Moblvac 3 suction source available from Ohio Medical Corporation of Gurnee, Ill. The suction source was set at a suctioning force of 120 mm Hg in the open circuit mode.

The suction swab has a raised suction control port projection extending approximately 10 mm from the body of the suction swab. The suction control port is an oval opening approximately 5.15 mm in width by approximately 11.5 mm in length to provide a total area of about 60 mm². The fluid passage through the suction swab was approximately 17 cm in length from the distal end of the tubular body to the proximal end of the body. The fluid passage was approximately 4.7 mm in diameter.

One Layer of Spunbond: A suction port cover was formed of a single layer of lightweight polypropylene spunbond fabric available from Kimberly-Clark Corporation, Roswell, Ga., having a basis weight of approximately 0.7 ounces per square yard (˜24 grams per square meter). The material has an air permeability of approximately 650 cubic feet per minute per square foot as determined utilizing a Textest FX 3300-II Air Permeability Tester device manufactured by Textest AG (Zurich, Switzerland), set to a pressure of 125 Pa with the normal 7-cm diameter opening (38 square centimeters area), which gives readings of Air Permeability in cubic feet per minute (CFM). The air permeability was an average was determined from tests of from three specimens. The spunbond fabric has a hydrostatic head of approximately 7.6 millibars (approximately 7.8 cm of H₂O) as determined in accordance with Federal Test Standard 191A, Method 5514 as described above utilizing a Textest FX-300 Hydrostatic Head Tester, available from Schmid Corporation, having offices in Spartanburg, S.C. was filled with purified water.

The suction swab was connected to the Moblvac 3 suction source which was set at a suctioning force of 120 mm Hg in the open circuit mode. When the initial two to three centimeters of the distal end of the suction swab was immersed in a container of de-ionized water and the suction swab was held at an angle of about 60 degrees from the horizontal plane (or about 30 degrees from the vertical plane), the water was not suctioned out of the container. When a finger was held over the suction port cover to divert the suctioning force to the suction tip and suction water from the container, the finger was not wetted by liquid entrained in the suction flow.

A dark blue-green food coloring was added to the de-ionized water in the container. A gloved finger (i.e., a finger that is covered by a nitrile rubber examination glove) was held directly on the spunbond fabric forming the suction control port cover to divert the suctioning force to the suction tip and suction the food-coloring-containing de-ionized water from the container. Two-thirds of the time (four out of a sample size of six), a small dot of dark blue-green food-coloring-containing de-ionized water about 0.5 mm in diameter or less (about the size of tip of a “fine” ball point pen) was observed on the glove finger held directly on the spunbond fabric forming the suction control port cover. One third of the time (two out of a sample size of six), there was an absence of any visually detectable dark blue-green food-coloring-containing de-ionized water on the glove finger held directly on the spunbond fabric forming the suction control port cover.

The spunbond fabric forming the suction control port cover was removed. When a gloved finger was held directly over the suction control port to divert the suctioning force to the suction tip and suction the dark blue-green food-coloring-containing de-ionized water from the container, food-coloring-containing water was observed on the gloved finger contacting the suction control port.

Two Layers of Spunbond: A suction port cover was formed of two layers of lightweight spunbond fabric available from Kimberly-Clark Corporation, Roswell, Ga. Each layer having a basis weight of approximately 0.7 ounces per square yard (˜24 grams per square meter) to provide a total basis weight of approximately 1.4 ounces per square yard (˜48 grams per square meter). The material has an air permeability of approximately 373 cubic feet per minute per square foot as determined utilizing a Textest FX 3300-II Air Permeability Tester device manufactured by Textest AG (Zurich, Switzerland), set to a pressure of 125 Pa with the normal 7-cm diameter opening (38 square centimeters area), which gives readings of Air Permeability in cubic feet per minute (CFM). The air permeability was an average was calculated from two test specimens. The suction swab was connected to the Moblvac 3 suction source which was set at a suctioning force of 120 mm Hg in the open circuit mode. When the initial two to three centimeters of the distal end of the suction swab was immersed in a container of water and the suction swab was held at an angle of about 60 degrees from the horizontal plane (or about 30 degrees from the vertical plane), the water was not suctioned out of the container. When a finger was held over the suction port cover to divert the suctioning force to the suction tip and suction water from the container, the finger was not wetted by liquid entrained in the suction flow.

A dark blue-green food coloring was added to the de-ionized water in the container. A gloved finger (i.e., a finger that is covered by a nitrile rubber examination glove) was held directly on the spunbond fabric forming the suction control port cover to divert the suctioning force to the suction tip and suction the food-coloring-containing de-ionized water from the container. For a sample size of three, there was an absence of any visually detectable dark blue-green food-coloring-containing de-ionized water on the glove finger held directly on the spunbond fabric forming the suction control port cover.

Four Layers of Spunbond: A suction port cover was formed of four layers of lightweight spunbond fabric available from Kimberly-Clark Corporation, Roswell, Ga. Each layer having a basis weight of approximately 0.7 ounces per square yard (˜24 grams per square meter) to provide a total basis weight of approximately 2.8 ounces per square yard (˜96 grams per square meter). The material has an air permeability of approximately 209 cubic feet per minute per square foot as determined utilizing a Textest FX 3300-II Air Permeability Tester device manufactured by Textest AG (Zurich, Switzerland), set to a pressure of 125 Pa with the normal 7-cm diameter opening (38 square centimeters area), which gives readings of Air Permeability in cubic feet per minute (CFM). The air permeability was an average was calculated from two test specimens. The suction swab was connected to the Moblvac 3 suction source which was set at a suctioning force of 120 mm Hg in the open circuit mode. When the initial two to three centimeters of the distal end of the suction swab was immersed in a container of water and the suction swab was held at an angle of about 60 degrees from the horizontal plane (or about 30 degrees from the vertical plane), the water was partially suctioned into the suction swab but was not suctioned out of the container. That is, the water was drawn up a slight distance into the suction swab but not out of the container. When a finger was held over the suction port cover to divert the suctioning force to the suction tip and suction water from the container, the finger was not wetted by liquid entrained in the suction flow. While the food coloring test was not conducted for the four layers of spunbond, it is expected there would be an absence of any visually detectable dark blue-green food-coloring-containing de-ionized water on a glove finger held directly on the spunbond fabric forming the suction control port cover.

As can be seen from these examples, one or more layers of a lightweight polypropylene spunbond material may be used as a breathable cover for a suction control port of a suction swab to prevent a finger used to cover the suction control port from becoming wetted by the liquid in the fluid flow passageway during suctioning. It should be noted that for a device having a suction control port having a cross-sectional area of about 60 mm², the lower limit on the air permeability of the material used as the breathable cover in the range of about 200 cubic feet per minute per square foot or less.

Lightweight Laminate Including a Meltblown Layer

This example illustrates the breathability of a lightweight three-layer laminate material composed of two layers of polypropylene spunbond material sandwiching a very light layer of meltblown fibers. The total basis weight of the laminate was approximately 1 ounce per square yard (˜34 gsm). The three-layer laminate material is available from Kimberly-Clark Corporation, Roswell, Ga. The material has an air permeability of approximately 56 cubic feet per minute per square foot as determined utilizing a Textest FX 3300-II Air Permeability Tester device manufactured by Textest AG (Zurich, Switzerland), set to a pressure of 125 Pa with the normal 7-cm diameter opening (38 square centimeters area), which gives readings of Air Permeability in cubic feet per minute (CFM). The air permeability was an average was determined from tests of from three specimens. This low level of breathability for a lightweight fabric was determined to be unacceptable for use as a breathable cover for a suction control port having a cross-sectional area of about 60 mm².

Spunbond Laminate

This example illustrates the breathability of a lightweight polypropylene spunbond material. The basis weight of the spunbond material was approximately 1 ounce per square yard (˜34 gsm). The spunbond material is used in the Level 1 Protection isolation gowns available from Medline Industries, Inc., Mundelein, Ill. The material has an air permeability of approximately 139 cubic feet per minute per square foot as determined utilizing a Textest FX 3300-II Air Permeability Tester device manufactured by Textest AG (Zurich, Switzerland), set to a pressure of 125 Pa with the normal 7-cm diameter opening (38 square centimeters area), which gives readings of Air Permeability in cubic feet per minute (CFM). The air permeability was an average was determined from tests of from three specimens. This low level of breathability for a lightweight fabric was determined to be unacceptable for use as a breathable cover for a suction control port having a cross-sectional area of about 60 mm².

Bacteria Filter

The Textest FX 3300-II Air Permeability Tester device manufactured by Textest AG (Zurich, Switzerland), was modified to measure air permeability for samples smaller than 38 cm in diameter. A one (1) inch (2.54 cm) diameter hole was cut in a sheet of heavy kraft paper to create a template. The template was centered over the orifice of the Textest device to occlude all but the 1-inch diameter hold. The device was run to assess the air flow with the 1-inch diameter sheet in place. The air flow was approximately 236 cubic feet per minute per square foot at a pressure of 125 Pa—since the tester assumes the normal 7-cm diameter opening (38 square centimeters area) and reports an airflow based on the assumption to generate an air flow (air permeability) reading in cubic feet per minute (CFM) per square foot.

A sample of lightweight polypropylene spunbond fabric available from Kimberly-Clark Corporation, Roswell, Ga., having a basis weight of approximately 0.7 ounces per square yard (˜24 grams per square meter) was tested both with and without the kraft paper template (with the 1 inch diameter hole). The Textest tester was run without the kraft paper template (with the 1-inch diameter hole) at a pressure drop of 125 Pa and the air permeability was measured at 670 cubic feet per minute per square foot (CFM/ft²) based on an average of three separate readings.

The kraft paper template (with the 1 inch diameter hole) was placed over the spunbond fabric while trying to avoid moving the spunbond fabric so that all portions of the 1 inch diameter hole were covered by the spunbond fabric and the 1-inch diameter hole was centered on the test orifice. The Textest tester was run at a pressure drop of 125 Pa and the air permeability was reported by the test equipment to be 91 CFM/ft² based on an average of three separate readings.

An approximated actual airflow through the tester was calculated for the spunbond material tested using the kraft paper template (with the 1-inch diameter hole) by multiplying the reported airflow (reported in cubic feet per minute per square foot) by a ratio. The ratio was determined by dividing the area of the 38 cm² test orifice (approximately 0.041 ft²) by the area of the 1-inch diameter opening (0.00545 ft²) in the template. The 91 CFM/ft² airflow was multiplied by the ratio (0.041/0.00545) to yield an airflow of 684 CFM/ft² which is within about 2 percent of the 670 CFM/ft² reading.

The bacteria filter from a tracheal suctioning catheter made by Vital Signs, Inc. of Totowa, N.J. was removed from its housing. The housing is illustrated in FIG. 5. The area of the suction control port 204 was approximately 80 square millimeters (mm²). The external area of the housing 206 was approximately 37 mm×37 mm. The surface area of the bacterial filter contained in the housing 206 that was available or open for air flow was approximately 830 square millimeters (mm²). The remaining portion of the bacterial filter was clamped on the perimeter of the housing. The bacterial filter was a two layer material containing a carded web layer that has been bonded by needlepunching and a layer of spunbond material. The carded web layer has a basis weight of about 520 grams per square meter and the spunbond layer has a basis weight of about 47 grams per square meter for a total basis weight of about 567 grams per square meter.

The bacteria filter was placed on the airflow test orifice of the Textest tester and the kraft paper template (with the 1 inch diameter hole) was placed over the bacteria filter so that all portions of the 1 inch diameter hole were covered by the bacteria filter. The Textest tester was run at a pressure drop of 125 Pa and the air permeability was reported by the test equipment to be 11 CFM/ft² based on an average of three separate readings. Multiplying the air flow reported for the bacteria filter tested using the kraft paper template (with the 1-inch hold) by the ratio determined by dividing the area of the 38 cm² test orifice (approximately 0.041 ft²) by the area of the 1-inch diameter opening (0.00545 ft²) in the template yields an approximate actual airflow of approximately 83 CFM/ft².

As a comparative example, a single layer of lightweight polypropylene spunbond fabric available from Kimberly-Clark Corporation, Roswell, Ga., having a basis weight of approximately 0.7 ounces per square yard (˜24 grams per square meter) was tested in an identical manner. The spunbond fabric was placed on the airflow test orifice of the Textest tester and the kraft paper template (with the 1 inch diameter hole) was placed over the spunbond fabric so that all portions of the 1 inch diameter hole were covered by the spunbond fabric. The Textest tester was run at a pressure drop of 125 Pa and the air permeability was reported by the test equipment to be 99 CFM/ft² based on an average of three separate readings. Multiplying the air flow reported for the spunbond fabric tested using the kraft paper template (with the 1-inch hold) by the ratio determined by dividing the area of the 38 cm² test orifice (approximately 0.041 ft²) by the area of the 1-inch diameter opening (0.00545 ft²) in the template yields an approximate actual airflow of approximately 745 CFM/ft².

This examples shows that bacteria filters and similar filter membranes have insufficient air permeability and are unacceptable for use as a breathable cover for a suction control port having a cross-sectional area of about 60 mm².

Thus there is disclosed an improved oral care suction device. Those skilled in the art will appreciate numerous modifications which can be made without departing from the scope and spirit of the present invention. The appended claims are intended to cover such modifications and their functional equivalents.

What is claimed is:

1. An oral care suction device comprising:
a body having a fluid flow passage formed therethrough, the body having a distal end, and a proximal end;
a suctioning feature located on or joined to the distal end of the body;
an attachment feature located on the proximal end, the attachment feature configured for joining the oral care suction device to a suction supply source;
a suction control port defining a channel from an exterior of the body to the fluid flow passage, the suction control port located intermediate the distal end and proximal end of the body, the suction control port configured to be covered by a finger or a portion of the hand of a user to alter the level of suction through the suctioning feature while allowing one hand operation of the suctioning device; and
a breathable fabric covering the suction control port so that contact of the finger or portion of the hand of a user with liquids and particles drawn into and through the fluid flow passage during suctioning is minimized.

2. The oral care suction device of claim 1, wherein the breathable fabric has a level of breathability sufficient to allow immersion of the suctioning feature in a liquid while the suction control port is uncovered by the finger or portion of the hand of a user without drawing off the liquid by suctioning.

3. The oral care suction device of claim 1, wherein the body further comprises a projection having a proximal end joined with the body and a distal end and the suction control port suction control port defining a channel from the distal end of the projection to the fluid flow passage.

4. The oral care suction device of claim 3, wherein the projection is integrally formed with the body.

5. The oral care suction device of claim 1, wherein the suctioning feature is integrally formed at the distal end of the body.

6. The oral care suction device of claim 1, wherein the attachment feature is integrally formed at the proximal end of the body.

7. The oral care suction device of claim 1, wherein the cross-sectional area of the channel defined by the suction control port ranges from about 20 square millimeters to about 120 square millimeters.

8. The oral care suction device of claim 1, wherein the air permeability of the breathable fabric is greater than about 60 ft³ per minute per ft² (1820 cm³ per minute per cm²) at a pressure condition of 125 pascals.

9. The oral care suction device of claim 1, wherein the suction control port defines a plurality of channels from the exterior of the body to the fluid flow passage.

10. The oral care suction device of claim 1, wherein the breathable fabric has a surface energy of less than about 45 dynes per centimeter (dynes/cm).

11. The oral care suction device of claim 1, wherein the breathable fabric provides resistance to water penetration as measured by a hydrostatic head of at least about 5 cm.

12. An oral care suction device comprising:
a body having a fluid flow passage formed therethrough, the body having a distal end, a proximal end,
a projection on the body having a proximal end joined with the body and a distal end, the projection located intermediate the distal end and proximal end of the body;
a suctioning feature located on or joined to the distal end of the body;
an attachment feature located on the proximal end, the attachment feature configured for joining the oral care suction device to a suction supply source;
a suction control port defining a channel from the distal end of the projection to the fluid flow passage, the suction control port configured to be covered by a finger or a portion of the hand of a user to alter the level of suction through the suctioning feature while allowing one hand operation of the suctioning device; and
a breathable fabric covering the suction control port so that contact of the finger or portion of the hand of a user with liquids and particles drawn into and through the fluid flow passage during suctioning is minimized.

13. The oral care suction device of claim 12, wherein the breathable fabric has a level of breathability sufficient to allow immersion of the suctioning feature in a liquid while the suction control port is uncovered by the finger or portion of the hand of a user without drawing off the liquid by suctioning.

14. The oral care suction device of claim 12, wherein the cross-sectional area of the channel defined by the suction control port ranges from about 20 square millimeters to about 120 square millimeters.

15. The oral care suction device of claim 12, wherein the air permeability of the breathable fabric is greater than about 60 ft³ per minute per ft² (1820 cm³ per minute per cm²) at a pressure condition of 125 pascals.

16. An oral care suction device comprising:
a body having a fluid flow passage formed therethrough, the body having a distal end, and a proximal end;
a suctioning feature located on or joined to the distal end of the body;
an attachment feature located on the proximal end, the attachment feature configured for joining the oral care suction device to a suction supply source;
a suction control port defining a channel extending from an exterior of the body to the fluid flow passage and having a cross-sectional area ranging from about 20 square millimeters to about 120 square millimeters, the suction control port located intermediate the distal end and proximal end of the body, the suction control port configured to be covered by a finger or a portion of the hand of a user to alter the level of suction through the suctioning feature while allowing one hand operation of the suctioning device; and
a breathable fabric having an air permeability greater than about 60 ft³ per minute per ft² (1820 cm³ per minute per cm²) at a pressure condition of 125 pascals and liquid barrier properties as measured by a hydrostatic head of at least about 5 cm, the breathable fabric covering the suction control port so that contact of the finger or portion of the hand of a user with liquids and particles drawn into and through the fluid flow passage during suctioning is minimized.

17. The oral care suction device of claim 16, wherein the breathable fabric has a level of breathability sufficient to allow immersion of the suctioning feature in a liquid while the suction control port is uncovered by the finger or portion of the hand of a user without drawing off the liquid by suctioning.

18. The oral care suction device of claim 16, wherein the body further comprises a projection having a proximal end joined with the body and a distal end and the suction control port suction control port defining a channel from the distal end of the projection to the fluid flow passage.

19. The oral care suction device of claim 16, wherein the suction control port defines a plurality of channels from the exterior of the body to the fluid flow passage.

20. The oral care suction device of claim 16, wherein the breathable fabric has a surface energy of less than about 45 dynes per centimeter (dynes/cm).
